(19) United States
(12) Patent Application Publication
(10) Pub. No.: US 2013/0257782 A1
(43) Pub. Date: Oct. 3, 2013

(54) INPUT SYSTEM

(71) Applicant: Toshiaki Nakagawa, Osaka (JP)

(72) Inventor: Toshiaki Nakagawa, Osaka (JP)

(73) Assignee: SHARP KABUSHIKI KAISHA, Osaka (JP)

(21) Appl. No.: 13/993,204

(22) PCT Filed: Dec. 7, 2011
(86) PCT No.: PCT/JP2011/078322

§ 371 Date: Jun. 11, 2013

(30) Foreign Application Priority Data
Dec. 14, 2010 (JP) 2010-278498

(51) Int. Cl. G06F 3/041

(52) U.S. Cl. CPC G06F 3/0416
USPC 345/173

(57) ABSTRACT

An input system according to the present invention includes: a plurality of input tools; and an input device configured to sense inputs of the input tools and recognize input locations. The input system is configured such that, upon sensing lights of optical styli, the input device alternately varies the sensing timing among the optical styli, and senses the light emitted by the optical styli according to the timing of the inputs of each optical stylus.

### TECHNICAL FIELD

The present invention relates to an input system that accepts input from an input tool such as a stylus, and more particularly, to an input system that accepts inputs at a plurality of locations.

### BACKGROUND ART

Electronic devices in which a liquid crystal display element such as a liquid crystal display screen is provided with a touch sensor function are widely used. The touch sensor function allows a user to start various functions freely just by touching the screen with a stylus or the like.

A liquid crystal display device disclosed in Patent Document 1 is shown in FIG. 11, for example. The liquid crystal display device shown in FIG. 11 includes a liquid crystal panel 140 and a backlight unit 150 including infrared light sources. The liquid crystal panel 140 includes an upper transparent substrate 141 including color filters RCF, GCF, and BCF and transparent windows W formed in the same layer; a lower transparent substrate 142 including thin film transistors (referred to as “TFT” below) for pixel selection and infrared sensing thin film transistors (referred to as “IRTFT” below) for sensing infrared; and a liquid crystal layer LC formed between the upper transparent substrate 141 and the lower transparent substrate 142.

On the lower transparent substrate 142 of the liquid crystal panel 140, a plurality of data lines and a plurality of gate lines are formed to intersect with each other, and a plurality of driving voltage lines in parallel with the gate lines, and a plurality of read-out lines intersecting with the gate lines and the driving voltage lines are formed. On the lower transparent substrate 142, TFTs for selecting the pixels are formed near intersections of the data lines and the gate lines, and the IRTFTs are formed near intersections of the driving voltage supply lines and the read-out lines. Also, pixel electrodes connected to the TFTs are formed. The TFTs for selecting pixels supply data voltages from the data lines to the pixel electrodes based on a scan signal from the gate line. When the upper transparent substrate 141 is touched by a hand of the user or a non-transparent object, each IRTFT senses the amount of infrared light reflected by the hand or the object through the upper transparent substrate 141 and the transparent window W, and outputs a sensing signal corresponding to the infrared amount via a read-out line.

When power is supplied to the liquid crystal panel 140, and when one or more fingers or objects are placed on the upper transparent substrate 141, the infrared light is reflected at the contact surface, and received by the IRTFTs. The infrared light received by the IRTFTs undergoes digital signal processing, pattern analysis, and the like in a digital signal processing circuit. As a result, a coordinate value of each touched point is calculated, and the digital signal processing circuit recognizes a plurality of touched points. At the same time, a touch image of each touched point is shown in the liquid crystal panel.

On the other hand, as shown in FIG. 12, a touch panel described in Patent Document 2 is an analog resistive type transparent touch panel. The touch panel includes a lower electrode member 204 in which an electrode made of a transparent conductive film and a pair of bus bars parallel to each other are formed on a transparent insulating substrate 201, and an upper electrode member 208 in which an electrode 206 made of a transparent conductive film and a pair of bus bars 207 parallel to each other are formed on the lower surface of a flexible transparent insulating substrate 205, and the lower electrode member 204 and the upper electrode member 208 are bonded to each other by an adhesive layer 210 provided on the edges thereof such that the bus bars of the lower electrode member 204 and the bus bars 207 of the upper electrode member 208 intersect with each other. Between the upper and lower electrodes, spacers 209 are interposed in a dot pattern. The lower electrode member 204 includes an electrode pattern 202L and a pair of bus bars 203L disposed in an area on the left side, and an electrode pattern 202R and a pair of bus bars 203R disposed in an area on the right side, and each pattern is controlled through a lead-out line 220 independently from each other. With this configuration, an input can be accepted in each of the two divided input areas of the left side input area where the electrode pattern 202L disposed on the left side of the lower electrode member 204 overlaps the electrode pattern 206 of the upper electrode member 208, and the right side input area where the electrode pattern 202R disposed on the right side of the lower electrode member 204 overlaps the electrode pattern 206 of the upper electrode member 208. Therefore, it is possible to accept inputs at two locations each in the left and right areas at the same time.

In addition to those described above, a touch panel that allows for a multi-touch operation is disclosed in Patent Document 3.

### RELATED ART DOCUMENTS

### Patent Documents

Patent Document 1: Japanese Patent Application Laid-Open Publication, “Japanese Patent Application Laid-Open Publication No. 2008-83675 (Published on Apr. 10, 2008)”
Patent Document 2: Japanese Patent Application Laid-Open Publication, “Japanese Patent Application Laid-Open Publication No. 2010-26641 (Published on Feb. 4, 2010)”
Patent Document 3: Japanese Patent Application Laid-Open Publication, “Japanese Patent Application Laid-Open Publication No. 2010-9412 (Published on Jan. 14, 2010)”

### SUMMARY OF THE INVENTION

### Problems to be Solved by the Invention

However, with the configurations described in Patent Documents 1 to 3, it is sometimes not possible to accurately detect each of inputs made by a plurality of styli at the same time when the user continuously inputs information with the plurality of styli at the same time such as inputting texts or drawing a line.

For example, as shown in FIG. 13(a), when the user draws a line from the point A to the point B using a first stylus 300A, and at the same time, draws a line from the point C to the point D using a second stylus 300B, with the configurations of Patent Documents 1 to 3, it is possible that these lines are erroneously recognized being drawn from the point A to the point D, and being drawn from the point C to the point B, respectively, as shown in FIG. 13(b).

Although a plurality of points are simultaneously recognized in the configurations of Patent Documents 1 to 3, in order to recognize letters or lines, it is necessary to know where the position recognized at one point in time is moved to at a next point in time. When a plurality of styli are used at the same time, letters or lines can be recognized by determining the closest position to the position detected at one point in time, among the points detected at a next point in time, as the input position made by the same stylus, but if the two styli are too close to each other, it is not possible to correctly determine which stylus made the particular input, and as a result, the problem shown in FIG. 13(b) occurs.

### Means for Solving the Problems

The present invention was made in view of the above-mentioned problem, and an object thereof is to provide an input system that allows a user to write letters or lines by using a plurality of styli at the same time.

That is, in order to solve the above-mentioned problem, an input system according to the present invention includes: a plurality of input tools; and an input device that can recognize input positions by sensing inputs of the input tools, wherein input timings of the respective input tools are configured differ from each other, and the input device senses the inputs in accordance with the input timings of the respective input tools, and wherein the input device connects input positions chronologically to detect continuous inputs for each of the input tools.

With this configuration, the sensing timings for the input tools are made to differ between the respective input tools, and inputs of the plurality of input tools are sequentially and repeatedly detected at certain intervals corresponding to the timings. Therefore, when an input of one input tool is sensed, an input of another input tool is not detected. That is, because the sensing operation is conducted for only one input tool, noise (input of another input tool) can be eliminated.

With the above-mentioned configuration, it is possible to detect inputs of the same input tool at a prescribed timing. That is, because inputs of the same input tool can be detected at prescribed intervals, by connecting respective input positions chronologically, it is possible to accurately recognize letters or lines.

As described above, because only one position on the input system is detected at a point in time, the input detection is not affected by an input of another input tool. Therefore, even when a plurality of input tools (input styli, for example) are used for continuous inputs at the same time, inputs of the respective input tools can be accurately detected.

Additional objects, features, and effects of the present invention shall be readily understood from the descriptions that follow. Advantages of the present invention shall become apparent by the following descriptions with reference to the appended drawings.

### Effects of the Invention

As described above, the input system of the present invention includes: a plurality of input tools; and an input device that can recognize input positions by sensing inputs of the input tools, wherein input timings of the respective input tools are configured to differ from each other, and the input device senses the inputs in accordance with the input timings of the respective input tools, and wherein the input device connects input positions chronologically to detect continuous inputs for each of the input tools.

As a result, when a plurality of input tools such as styli are used to provide continuous inputs such as writing letters or drawing lines at the same time, such inputs can be accurately detected.

### BRIEF DESCRIPTION OF THE DRAWINGS

FIG. 1 is a block diagram showing a configuration of an input system according to an embodiment of the present invention.

FIG. 2 is a cross-sectional view of a structure of an optical stylus that is an input tool included in the input system of an embodiment of the present invention.

FIG. 3 is a circuit diagram showing a part of the configuration of the input system according to an embodiment of the present invention.

FIG. 4 is a timing chart of a driving method for the input system of an embodiment of the present invention.

FIG. 5 is an exterior view of a touch sensor display device as an electronic device equipped with the input system of the present invention.

FIG. 6 is a block diagram showing a configuration of an input system according to another embodiment of the present invention.

FIG. 7 is a block diagram showing a configuration of an input system according to another embodiment of the present invention.

FIG. 8 is a timing chart of a driving method for an input system of another embodiment of the present invention.

FIG. 9 is a diagram showing a configuration of an input system according to another embodiment of the present invention.

FIG. 10 is a diagram showing a configuration of an input system according to another embodiment of the present invention.

FIG. 11 is a diagram showing a conventional technology.

FIG. 12 is a diagram showing a conventional technology.

FIG. 13 is a diagram showing a conventional technology.

### DETAILED DESCRIPTION OF EMBODIMENTS

### Embodiment 1

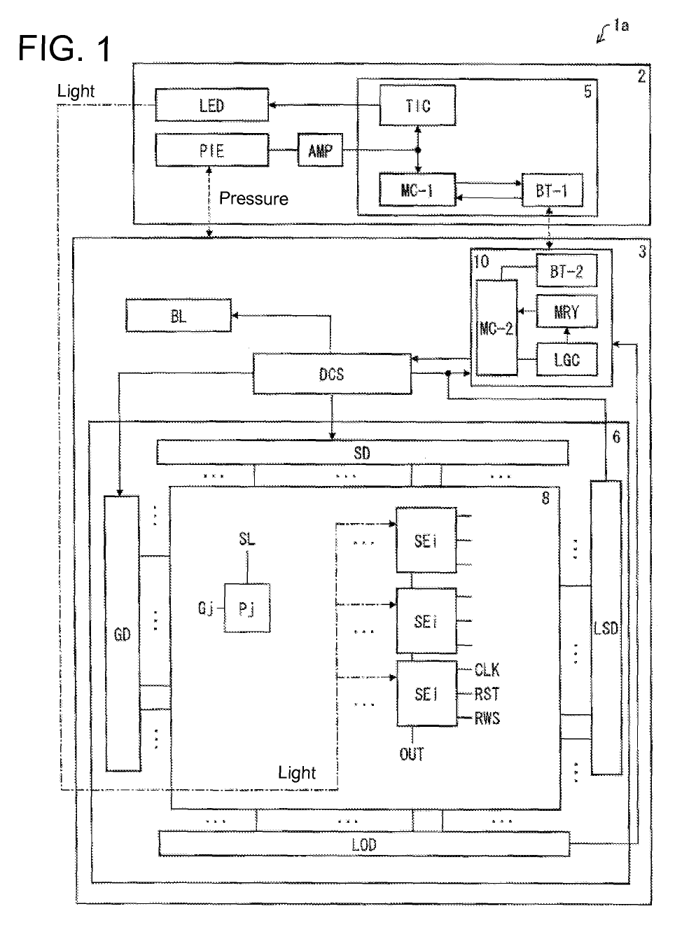

An embodiment of an input system of the present invention will be explained below with reference to FIGS. 1 to 5.

(Configuration of Input System)

FIG. 1 is a block diagram showing a configuration of the input system of the present embodiment.

The input system of the present invention can be used as an input system equipped with a touch sensor function (text input function, in particular), and for example, can be used as an input device equipped with a touch sensor. Also, the input system of the present invention can be suitably used for any electronic device equipped with a touch sensor function (text input function, in particular).

As shown in FIG. 1, the input system 1a of the present embodiment includes an optical stylus 2 (input tool) and an input device 3 having a backlight BL.

Optical Stylus (Input Tool)

The optical stylus 2 includes a light-emitting diode LED, a pressure element PIE, a control board 5, and an amplifier circuit AMP.

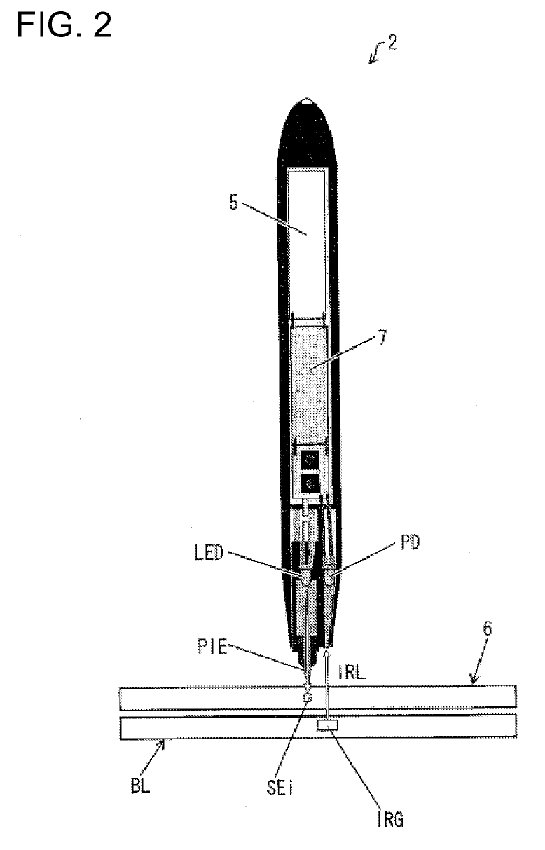

The configuration of the optical stylus 2 will be described in detail with reference to FIG. 2.

As shown in FIG. 2, in the optical stylus 2, a battery 7 is provided in the center of the stylus, the control board 5 is provided next to the battery 7 on the side opposite to the tip, the light-emitting diode LED is provided near the battery 7 on the side closer to the tip, and the pressure element PIE is provided at the tip.

There is no special limitation on the battery 7, and a known small battery can be used.

The light-emitting diode LED (light-emitting element) emits light that is to be detected by a photosensor circuit SEi in a photosensor touch panel 6 provided in the input device 3. The light emission from the light-emitting diode LED is controlled by the control board 5 and a recognition engine 10 provided in the input device 3, which will be later described.

The pressure element PIE detects a pressure generated between the tip of the optical stylus 2 and the surface of the photosensor touch panel 6 provided in the input device 3, when the tip is pressed against the surface. The detection result from the pressure element PIE is inputted into a microcomputer MC-1 (pressure signal generator) in the control board 5 via the amplifier circuit AMP, and is digitized to approximately 1024 level, for example, thereby generating a pressure signal. The pressure signal is inputted into the recognition engine 10 via a Bluetooth (registered trademark) communication circuit BT-1 and a Bluetooth (registered trademark) communication circuit BT-2 of the recognition engine 10 of the input device 3.

The control board 5 includes a timing IC (TIC), the microcomputer MC-1, and the Bluetooth (registered trademark) communication circuit BT-1.

The timing IC (TIC) controls light emission from the light-emitting diode LED based on the detection result from the pressure element PIE and the control signal from the microcomputer MC-1. The driving method based on the timing IC will be described later.

The microcomputer MC-1 outputs the control signal, which is sent from the recognition engine 10 via the Bluetooth (registered trademark) communication circuit BT-1 and the Bluetooth (registered trademark) communication circuit BT-2 of the recognition engine 10 of the input device 3, to the timing IC (TIC) together with the pressure signal, and controls a light emission timing of the light-emitting diode LED.

The Bluetooth (registered trademark) communication circuit BT-1 communicates wirelessly with the Bluetooth (registered trademark) communication circuit BT-2 provided in the input device 3.

The Bluetooth (registered trademark) communication circuit BT-2 provided in the recognition engine 10 and the Bluetooth (registered trademark) communication circuit BT-1 provided in the control board 5 of the optical stylus 2 are not limited to Bluetooth (registered trademark), and a known wireless communication device such as ZigBee may be used.

Input Device

The input device 3 includes the photosensor touch panel 6, a display control circuit DCS, the backlight BL, and the recognition engine 10 (control part, output part).

The photosensor touch panel 6 includes a display part 8, a source driver SD, a gate driver GD, a photosensor driver circuit LSD (output part), and a photosensor output circuit LOD (output part).

The display part 8 includes a plurality of pixels Pj arranged in a matrix, a plurality of scan signal lines Gj, a plurality of data signal lines SL, a plurality of photo sensor circuits SEi arranged in a matrix, a plurality of clock signal lines CLKi, a plurality of reset signal lines RSTi, a plurality of read-out signal lines RWSi, and a plurality of photosensor output lines OUT (output part) (i=1 . . . n, j=1 . . . m). The configuration of the photosensor circuit SEi will be later described.

The display control circuit DCS controls the source driver SD, the gate driver GD, the photosensor driver circuit LSD, the recognition engine 10, and the backlight BL.

The source driver SD drives the data signal lines SL, and the gate driver GD drives the scan signal lines Gj.

The photosensor driver circuit LSD drives the clock signal lines CLKi, the reset signal lines RSTi, and the read-out signal lines RWSi. The recognition engine 10 drives the photosensor output circuit LOD connected to the photosensor output lines OUT.

The recognition engine 10 is constituted of a microcomputer MC-2, a logic part LGC, a memory MRY, and the Bluetooth (registered trademark) communication circuit BT-2. The microcomputer MC-2 and the logic part LGC calculate a touched point (input position coordinates), based on a sensor image sent to the recognition engine 10 from the plurality of photosensor output lines OUT via the photosensor output circuit LOD. The memory MRY has a calibration image stored therein, which is mainly used in a process (calibration) conducted prior to the recognition of the sensor image. The Bluetooth (registered trademark) communication circuit BT-2 provided in the recognition engine 10 communicates wirelessly with the Bluetooth (registered trademark) communication circuit BT-1 provided in the control board 5 in the optical stylus 2.

(Operation of Input System (Sensing))

In the input system 1a having the above-mentioned configuration, light from the light-emitting diode LED of the optical stylus 2 is sensed, and an input position, i.e., a position to which the light from the light-emitting diode LED was radiated, is detected.

In the present invention, sensing timings are configured to differ between the respective optical styli, and by repeatedly and sequentially sensing the inputs of the plurality of optical styli at the prescribed timing, inputs of the respective the optical styli can be accurately detected even when a plurality of optical styli 2 are used at the same time, thereby allowing a user to input letters or draw lines.

Below, a sensing operation using two optical styli 2 will be explained, but in the present invention, the number of the optical stylus may be one or three or more.

In the present embodiment, the display control circuit DCS generates a control signal that defines timings at which the input device 3 obtains sensing results from the photosensor circuits SEi via the photosensor output lines OUT and the photosensor output circuit LOD. The control signal controls both the timings to emit light from the optical stylus 2 and the sensing timings.

In order to control the light emission of the optical stylus 2, the control signal is sent to the Bluetooth (registered trademark) communication circuit BT-1 provided in the control board 5 of the optical stylus 2 via the Bluetooth (registered trademark) communication circuit BT-2 provided in the recognition engine 10, and the control signal is sent to the microcomputer MC-1 provided in the control board 5 from the Bluetooth (registered trademark) communication circuit BT-1.

The control signal sent to the microcomputer MC-1 of the control board 5 is used in a different manner in each optical stylus 2. Below, the two optical styli 2 will be explained separately as a first optical stylus 2 and a second optical stylus 2.

The microcomputer MC-1 of the first optical stylus 2 generates a synchronization signal that synchronizes only with the odd-numbered ON periods of the control signal, and sends the synchronization signal to the timing IC (TIC).

In addition, when the pressure element PIE detects a pressure, the microcomputer MC-1 generates a pressure signal based on the detection result, and sends the pressure signal to the timing IC (TIC) together with the synchronization signal.

The timing IC (TIC) receives the synchronization signal and the pressure signal, and when the timing IC (TIC) receives a digital signal that indicates that the pressure element PIE applies a pressure to the input device 3, that is, when the pressure signal is on, the timing IC (TIC) drives the light-emitting diode LED provided at the tip of the first optical stylus 2 to emit light. At this time, the photosensor touch panel 6 performs a sensing operation.

On the other hand, the microcomputer MC-1 of the second optical stylus 2 sends to the timing IC (TIC) a synchronization signal that synchronizes only with the even-numbered ON periods of the control signal. The light-emitting diode LED provided at the tip of the second optical stylus 2 is driven to emit light in the same manner as in the first optical stylus 2.

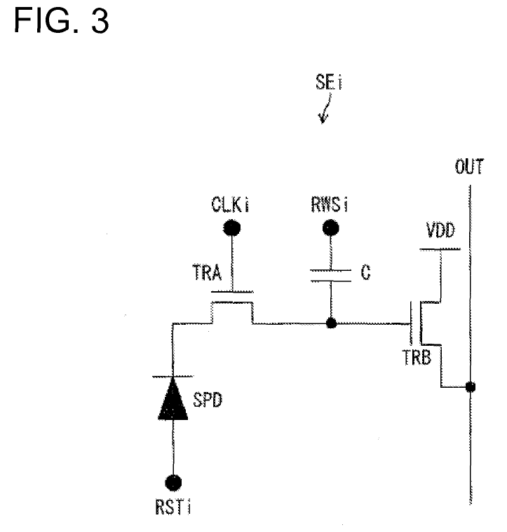

Next, the operation of the photosensor circuit SEi when the light is emitted will be explained with reference to FIG. 3.

FIG. 3 is a circuit diagram showing a configuration of the photosensor circuit SEi provided in the photosensor touch panel 6 shown in FIG. 1. As shown in FIG. 3, the photosensor circuit SEi includes a photodiode SPD, a transistor TRA, a capacitance C, and a transistor TRB. The anode of the photodiode SPD is connected to a reset signal line RSTi. The cathode of the photodiode SPD is connected to one electrode of the capacitance C and the control electrode of the transistor TRB through the transistor TRA. The other electrode of the capacitance C is connected to a read-out line RWSi. The control electrode of the transistor TRA is connected to a clock signal line CLKi. One of the conductive electrodes of the transistor TRB is connected to VDD, and the other conductive electrode is connected to a photosensor output line OUT. The photosensor output line OUT is connected to the photosensor output circuit LOD.

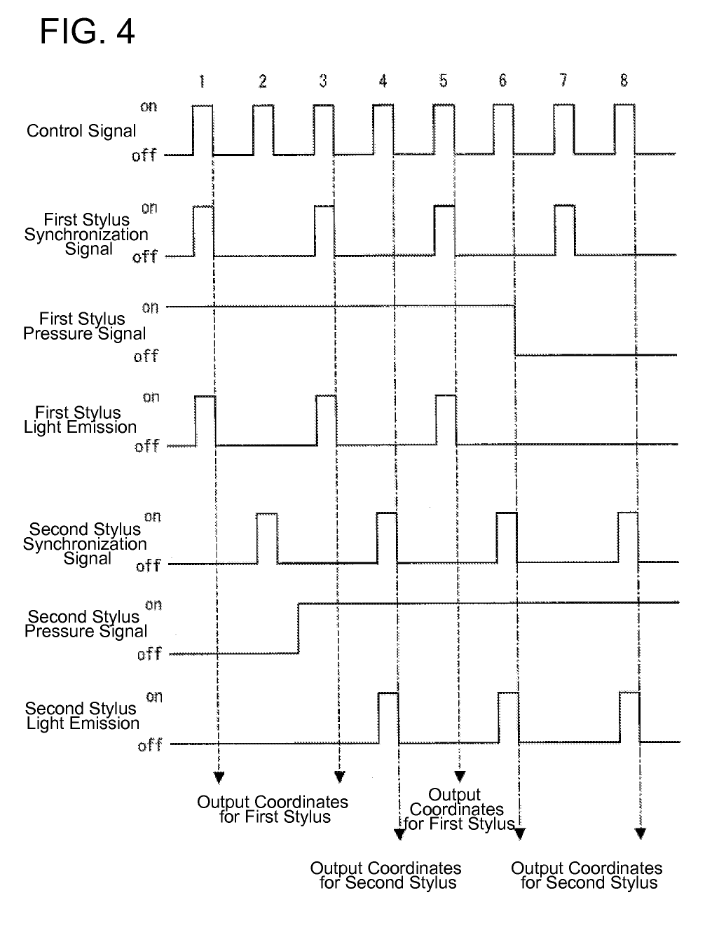

FIG. 4 is a timing chart illustrating the above-mentioned driving method. FIG. 4 specifically shows how the sensing operation, the first optical stylus 2, and the second optical stylus 2 are synchronized with each other, and therefore, the operation will be explained again with reference to FIG. 4.

When the control signal is on, each photosensor circuit accumulates charges in the capacitance C corresponding to a light intensity, and immediately after the control signal is turned off, the potential corresponding to the accumulated charges is outputted.

The synchronization signal of the first optical stylus 2 is turned on, synchronizing only with the odd-numbered ON periods of the control signal. The pressure element PIE provided in the first optical stylus 2 detects a pressure when the tip of the stylus touches the screen, and the pressure signal is turned on. The first optical stylus 2 is configured so as to emit light only when the synchronization signal and the pressure signal are both on. In FIG. 4, the first optical stylus 2 only emits light in the ON periods of 1, 3, and 5 of the control signal, and the coordinates at which the first optical stylus 2 is present is outputted in these periods. In other words, even if the pressure signal of the first optical stylus 2 is on during the even-numbered ON periods of the control signal, the first optical stylus 2 does not emit light, or the sensing operation therefor is not conducted.

The control signal is turned on and off once in every frame period (1/60 seconds). However, when the sensitivity of the photosensor is high, and the rapid sensing is possible, the control signal can be turned on and off twice during a single frame period, and the coordinates of the two styli can be obtained for each frame period. As a result, smoother display can be achieved.

The synchronization signal of the second optical stylus 2 is turned on, synchronizing only with the even-numbered ON periods of the control signal. In a manner similar to above, the pressure signal of the second optical stylus 2 is turned on when the second optical stylus 2 touches the screen, and in the example of the figure, the coordinates at which the second optical stylus 2 is present are outputted in the ON periods 4, 6, and 8 of the control signal. In other words, even if the pressure signal of the second optical stylus 2 is on during the odd-numbered ON periods of the control signal, the second optical stylus 2 does not emit light, or the sensing operation therefor is not conducted.

As described above, in each sensing cycle, only one set of coordinates is outputted, which makes it possible to output coordinates for two styli in the single touch type touch panel.

Even with three or more optical styli, by having the synchronization signal of each optical stylus turn on in each of the ON periods of the control signal, it is possible to output coordinates of the respective styli while identifying each of the styli.

The reset operation is conducted right after the control signal is turned on from off. The charges are accumulated during the ON period, and immediately after switching from on to off, the output operation is conducted.

### Modification Example 1

A method without using a pressure signal of an optical stylus can be employed as a modification example of the present embodiment.

In this case, the optical stylus 2 emits light every time the control signal of the optical stylus is turned on. The intensity of emitted light of the optical stylus in this case is adjusted to a level that can be sensed by the photosensor circuit Sei when the tip of the stylus is very close to the input device.

### Modification Example 2

In the present embodiment, light emission is employed as the input method for the input device, but the present invention is not limited to such. As long as the device employs a mechanism in which a certain type of signal (corresponding to light in the case of photosensor) is emitted from an input tool such as a stylus, and the coordinate position is obtained by receiving the signal at the input device, the certain type of signal does not need to be light. For example, electromagnetic induction, which will be later described, an infrared camera, and the like can be employed.

(Configuration of Electronic Device Provided with Input System)

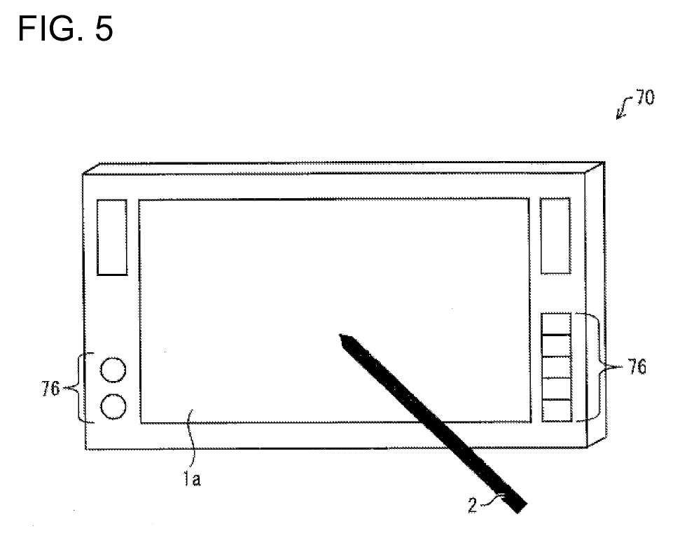

The input system of the present embodiment can be provided in an electronic device as described above. A display device as one embodiment thereof is shown in FIG. 5.

FIG. 5 is a diagram showing a display device of a touch sensor type (touch panel). A display device 70 of the present embodiment is provided with an input system 1a as shown in FIG. 5.

Near the input system 1a, a group of operation buttons 76 is provided. The group of operation buttons 76 is constituted of a group of function buttons for inputting various setting and changing functions of the display device 70 and the like.

The display device 70 of the present embodiment is equipped with the above-mentioned input system 1a having the touch sensor function in the display part. Therefore, a part of the group of operation buttons 76 described above can be operated through touch sensors in the display part, for example, instead of the button operation.

The display device 70 may also be provided with a speaker, a microphone, an image capturing element, and the like.

(Another Example of Electronic Device)

Another example of the electronic device is an electronic board. The electronic board is a white board that can electronically convert the contents written on the board, and is also referred to as a copy board.

The electronic board is increasingly used in offices, schools, and the like, and it is effective to use the input system of the present invention in such an electronic board because the accurate sensing can be performed even when a plurality of operators conduct an input operation at the same time.

In addition to the electronic board, the present invention can be applied to an input system for a large screen.

### Effects of the Present Embodiment

According to the configuration of the present embodiment, the sensing timings are made to differ between respective optical styli, and inputs of a plurality of optical styli are detected sequentially and repeatedly at certain intervals in accordance with the timings. Therefore, at a time when an input of one optical stylus is detected, an input of the other optical stylus is not detected. As a result, it is possible to sense the input of the particular optical stylus without noise (input of the other optical stylus).

With the above-mentioned configuration, the inputs of the same optical stylus can be detected at prescribed intervals, and by connecting the respective input positions chronologically, it is possible to recognize letters or lines accurately.

As described above, only one position on the input system is detected at one point in time, and therefore, the input detection is not affected by input from another optical stylus. Therefore, even when continuous inputs are made by using a plurality of optical styli at the same time, the inputs of each optical stylus can be detected accurately.

Also, the sensing timing is set according to the control signal and the pressure signal, and therefore, it is not necessary to constantly emit light from the optical stylus, and instead, the optical stylus can be configured so as to emit light only during the sensing operation. As a result, as compared with the case in which the optical stylus is constantly in a sensing-ready state, the power consumption relating to an input operation can be reduced.

Also, by employing a configuration in which a pressure signal is generated, it is possible to make the optical stylus conduct an input operation (based on the pressure signal and the control signal) only when the user intends to conduct an input operation on the input device. In other words, it is possible to prevent an input operation from being conducted unintentionally. Specifically, with the configuration of the present embodiment, when the optical stylus is not pressed against the input device, that is, when the user does not intend to input anything, the optical stylus does not emit light. This makes it possible to reduce the power consumption due to unnecessary light emission. Also, it is possible to prevent erroneous input as a result of one optical stylus emitting light near the other optical stylus while the sensing operation for the other optical stylus is conducted.

### Embodiment 2

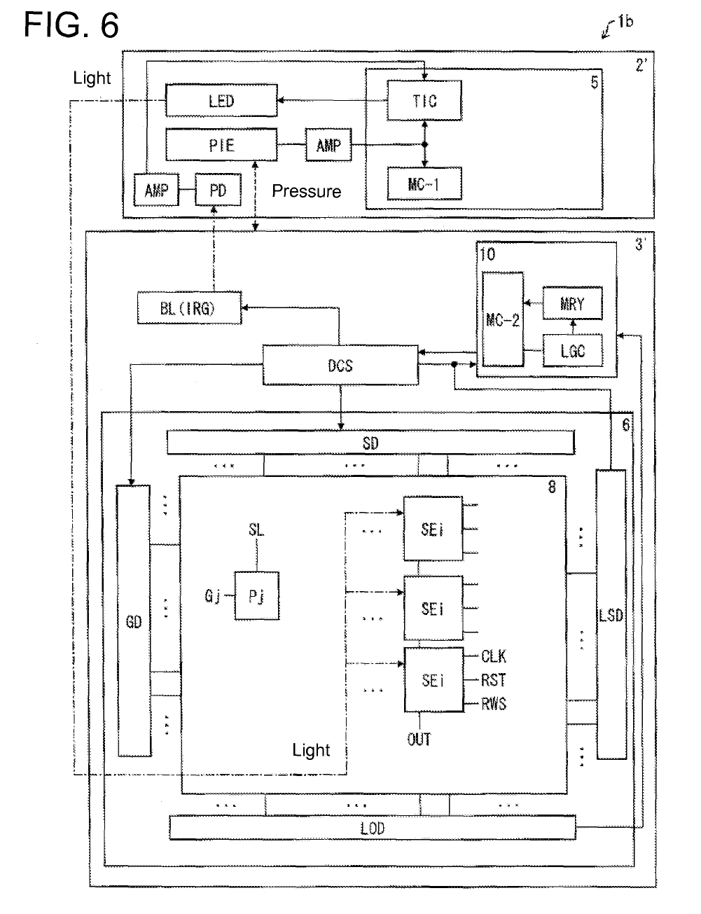

Another embodiment according to the present invention is as described below with reference to FIG. 6. In the present embodiment, differences from Embodiment 1 above will be described, and for ease of explanation, components having the same functions as those described in Embodiment 1 are given the same reference characters, and the descriptions thereof are omitted.

As shown in FIG. 1, in the input system 1a of Embodiment 1 described above, the control signal sent from the recognition engine 10 is transmitted to the timing IC (TIC) through a wireless communication device, thereby controlling a timing to emit light from the light-emitting diode LED. By contrast, in the present embodiment, the backlight BL of the input device 3 includes an infrared light generator IRG, and the timing to emit light from the optical stylus is controlled by having the optical stylus receive infrared light that is emitted at a desired timing.

Specifically, as shown in FIG. 6, the input device 3′ of an input system 1b of the present embodiment, the backlight BL includes the infrared light generator IRG. The recognition engine 10 of the input device 3′ does not include the Bluetooth (registered trademark) communication circuit BT-2 or a mechanism to send a control signal to the optical stylus, unlike Embodiment 1.

The display control circuit DCS of the input device 3′ controls the source driver SD, the gate driver GD, the photosensor driver circuit LSD, the recognition engine 10, and the backlight BL that includes the infrared light generator IRG.

The optical stylus 2′ of the input system 1b of the present embodiment is provided with a photodiode PD. The control board 5 of the optical stylus 2′ does not include the Bluetooth (registered trademark) communication circuit BT-1, unlike Embodiment 1.

The photodiode PD receives infrared light IRL emitted from the infrared light generator IRG in the backlight BL provided to the input device 3′. As described above, the optical stylus 2′ can receive (detect) through the photodiode PD infrared light from the infrared light generator IRG in the backlight BL provided in the input device 3. The detection result of the photodiode PD is inputted into the timing IC (TIC) through an amplifier circuit AMP.

The microcomputer MC-1 provided in the control board 5 of the optical stylus 2′ controls light emission of the light-emitting diode LED based on the detection results of the photodiode PD and the pressure element PIE.

That is, based on the detection result of the photodiode PD sent via the timing IC (TIC), the microcomputer MC-1 sends to the timing IC (TIC) a synchronization signal to synchronize the light emission timing of the light-emitting diode LED with the timing of sensing.

Below, in a manner similar to Embodiment 1, the description is made by using a first optical stylus 2′ and a second optical stylus 2′.

The microcomputer MC-1 of the first optical stylus 2′ generates a synchronization signal that synchronizes only with odd-numbered ON periods of the light-receiving signal of the photodiode PD, and the synchronization signal is sent to the timing IC (TIC). In addition, when the pressure element PIE detects a pressure, the microcomputer MC-1 of the first optical stylus 2′ generates a pressure signal based on the detection result, and sends the pressure signal to the timing IC (TIC) together with the synchronization signal.

The timing IC (TIC) receives the synchronization signal and the pressure signal, and when a digital signal that indicates that the pressure element PIE applies a pressure on the input device 3 is received, the timing IC (TIC) drives the light-emitting diode LED provided at the tip of the first optical stylus 2 to emit light.

On the other hand, the microcomputer MC-1 of the second optical stylus 2′ generates a synchronization signal that synchronizes only with even-numbered ON periods of the light-receiving signal of the photodiode PD, and the synchronization signal is sent to the timing IC (TIC). The light-emitting diode LED provided at the tip of the second optical stylus 2′ is driven to emit light in the same manner as in the first optical stylus 2.

As described in the present embodiment, by emitting infrared light from the input device 3′, the light emission from each optical stylus 2′ and the sensing operation for inputs through the light emission can be synchronized with each other, and by making the timing of sensing differ for each optical stylus 2′, it is possible to accurately detect an input of each optical stylus 2′ as in Embodiment 1 above.

### Modification Example

In the present embodiment, a configuration in which infrared light is emitted from the input device 3′ and the optical stylus 2′ receives the infrared light was described, but the present invention is not limited to such, and it is also possible to use a change in magnetic field. That is, it is possible to employ a configuration in which the input device 3′ is provided with a coil to generate a magnetic field, and a change thereof is detected by a coil provided in the optical stylus 2′. This way, it is possible to realize a configuration in which the optical stylus 2′ emits light only when the change in magnetic field is detected.

### Embodiment 3

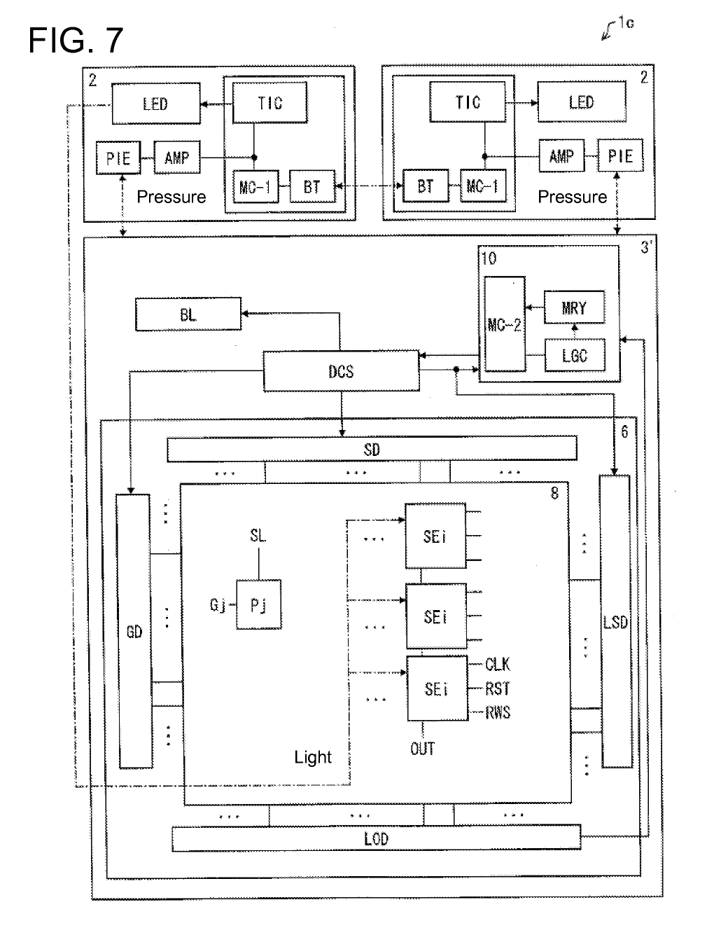

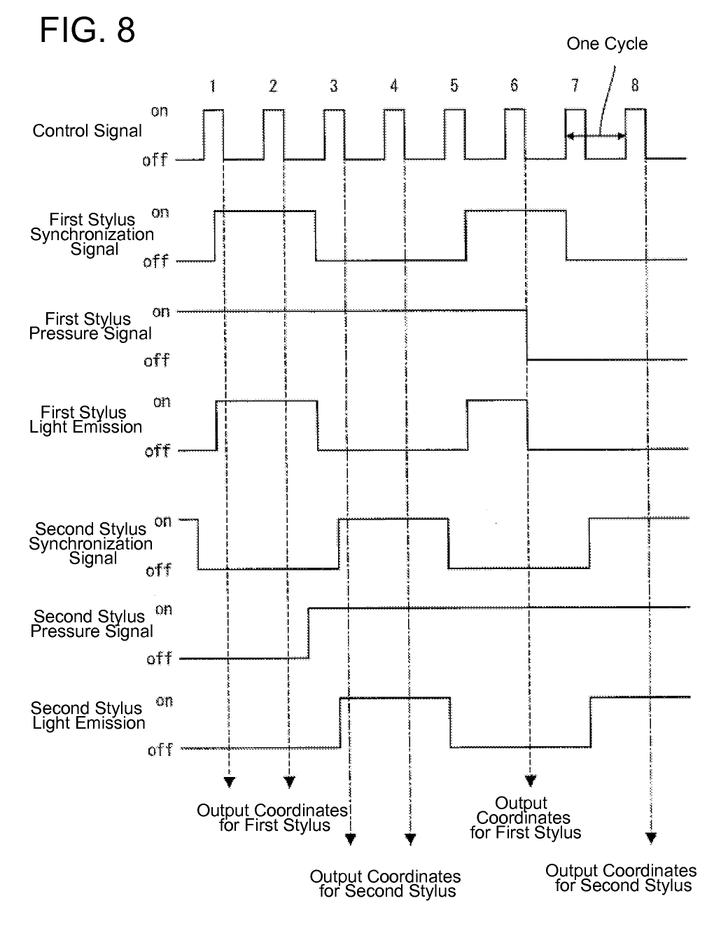

Another embodiment according to the present invention is as described below with reference to FIGS. 7 and 8. In the present embodiment, differences from Embodiment 1 above will be described, and for ease of explanation, components having the same functions as those described in Embodiment 1 are given the same reference characters, and the descriptions thereof are omitted.

In the input system 1a of Embodiment 1 described above, the control signal is sent to every optical stylus 2 from the input device 3, and each optical stylus 2 emits light at a prescribed timing based on the received control signal. By contrast, in the present embodiment, a plurality of optical styli 2 is synchronized by communicating with each other.

Specifically, as shown in FIG. 7, in an input system 1c of the present embodiment, the input device 3′ that generates a control signal does not have a mechanism to send the control signal to optical styli 2. On the other hand, each of the optical styli 2 has a Bluetooth (registered trademark) communication circuit BT that allows a wireless communication between the optical styli 2.

FIG. 8 is a timing chart that shows a driving method of the input system 1c of the present embodiment. When the synchronization is realized only between the optical styli 2 as in the present embodiment, the synchronization signals of the first optical stylus 2 and the second optical stylus 2 are controlled such that ON and OFF periods thereof become opposite to each other.

The ON period of the synchronization signal of each optical stylus 2 is set to be equal to or longer than one sensing period (a period of time from a start of one sensing operation to a start of the next sensing operation). As a result, without making the sensing operation and the synchronization signals of the styli synchronized with each other, at least one sensing operation is conducted during the ON period of the synchronization signal of each stylus.

Also, a period of time between when the synchronization signal (input control signal) of one optical stylus is turned off from on and when the synchronization signal of the other optical stylus is turned on from off is longer than a single ON period of the control signal for sensing. As a result, it is possible to ensure that only one optical stylus emits light during a single sensing period.

As described above, with the configuration of the present embodiment, in a manner similar to the respective embodiments above, by making the timing of sensing differ for each optical stylus 2′, it is possible to detect an input from every optical stylus 2′ accurately.

### Embodiment 4

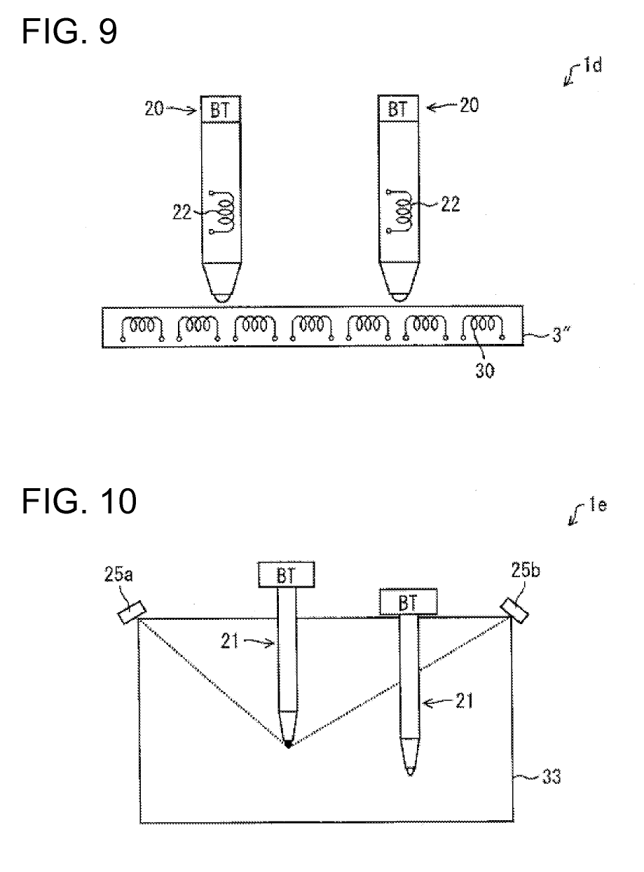

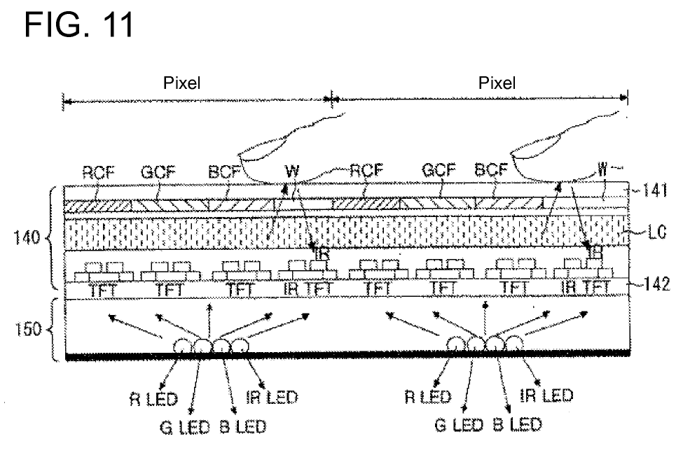

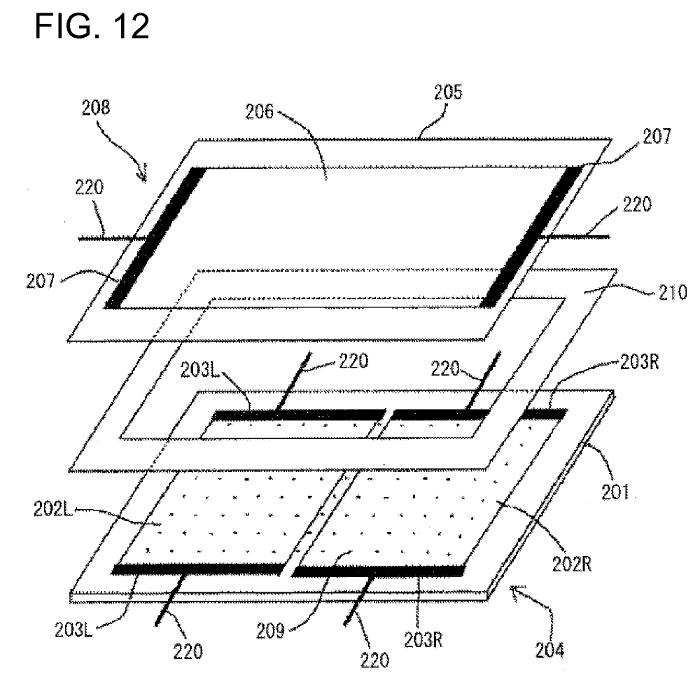

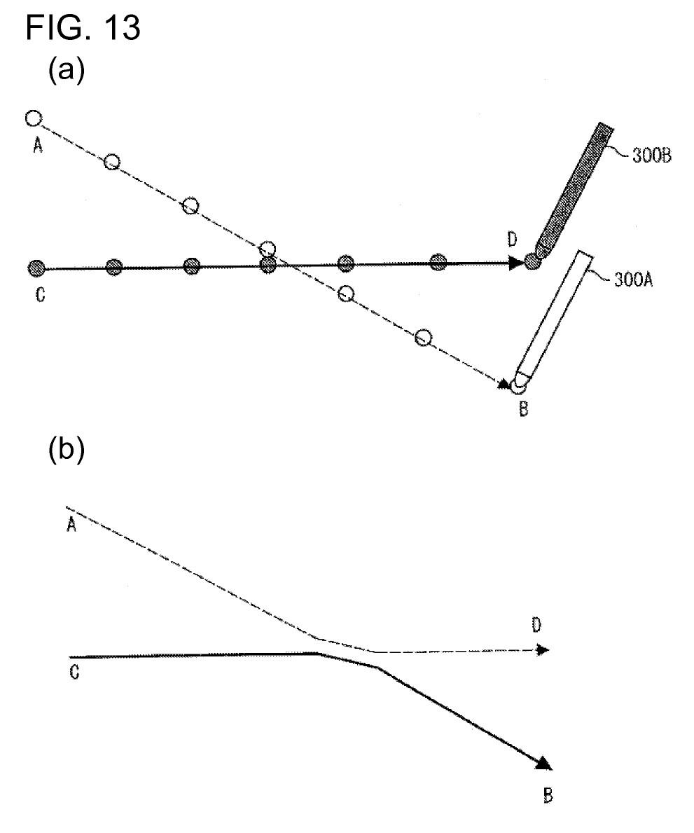

Another embodiment according to the present invention is as described below with reference to FIG. 9. In the present embodiment, differences from Embodiment 1 above will be described, and for ease of explanation, components having the same functions as those described in Embodiment 1 are given the same reference characters, and the descriptions thereof are omitted.

In the input system 1a of Embodiment 1 above, as described in FIG. 1, an input operation is conducted on the input device through emitting light from the optical stylus. By contrast, in an input system 1d of the present embodiment, as shown in FIG. 9, an electromagnetic stylus 20 is used as an input tool for an input device 3″. The electromagnetic stylus 20 is provided with a coil 22 and a Bluetooth (registered trademark) communication circuit BT, and with the coil 22, a magnetic field near the stylus is changed. The Bluetooth (registered trademark) communication circuit BT may be used to have respective electromagnetic styli 20 synchronize with each other, or it is also possible to provide a Bluetooth (registered trademark) communication circuit to the input device 3″ such that this circuit and the Bluetooth (registered trademark) communication circuit BT of the electromagnetic stylus 20 can communicate with each other.

On the other hand, the input device 3″ is provided with coils 30 to detect a change in magnetic field, and the position of the stylus can be identified.

By controlling the magnetic field from each electromagnetic stylus 20 in a manner similar to Embodiments 1 to 3 above, it is possible to determine the coordinates obtained by the input device 3″ belongs to which electromagnetic stylus.

The timing of sensing and the timing of changing the magnetic field may be synchronized with each other by using a control signal sent from the input device to an input tool (optical stylus) as in Embodiment 1 above, or by having respective input tools synchronize with each other as in Embodiment 3.

### Embodiment 5

Another embodiment according to the present invention is as described below with reference to FIG. 10. In the present embodiment, differences from Embodiment 1 above will be described, and for ease of explanation, components having the same functions as those described in Embodiment 1 are given the same reference characters, and the descriptions thereof are omitted.

In the input system 1a of Embodiment 1 above, as described in FIG. 1, an input operation is conducted on the input device through emitting light from the optical stylus. By contrast, in an input system le of the present embodiment, as shown in FIG. 10, a stylus 21 that emits infrared light is used as an input tool for an input device 33. The stylus 21 is provided with an infrared light source that emits infrared light, and with the infrared light source, infrared light is emitted from the tip of the stylus.

On the other hand, the input device 33 is provided with a plurality of infrared cameras 25a and 25b that receive infrared light emitted from the stylus 21 that is close to the screen. The infrared cameras are placed near the screen in at least two positions that differ from each other. As a result, the coordinate position of the stylus can be obtained through triangulation.

By controlling the infrared light emitted from each stylus 21 in a manner similar to Embodiments 1 to 3 above, it is possible to determine the coordinates obtained by the input device 33 belongs to which stylus.

The present invention is not limited to the embodiments above. Various modifications can be made to the present invention by those skilled in the art without departing from the scope specified by claims. That is, new embodiments can be obtained by combining technologies that were appropriately modified in the scope specified by claims. The specific embodiments provided in the detailed description of the present invention section are merely for illustration of the technical contents of the present invention. The present invention shall not be narrowly interpreted by being limited to such specific examples. Various changes can be made within the spirit of the present invention and the scope as defined by the appended claims.

### SUMMARY OF THE INVENTION

As described above, the input system of the present invention includes: a plurality of input tools; and an input device that can recognize input positions by sensing inputs of the input tools, wherein input timings of the respective input tools are configured to differ from each other, and the input device senses the inputs in accordance with the input timings of the respective input tools, and wherein the input device connects input positions chronologically to detect continuous inputs for each of the input tools.

With this configuration, the sensing timings are made to differ between the respective input tools, and inputs of each of a plurality of input tools are detected sequentially and repeatedly at prescribed intervals in accordance with the timings. Therefore, when an input of a certain input tool is sensed, an input of another input tool is not detected. In other words, because the sensing operation is conducted for only one input tool, noise (input of another input tool) can be eliminated.

With the above-mentioned configuration, inputs of the same input tool can be detected at a prescribed timing. That is, inputs of the same input tool can be detected at prescribed intervals, and therefore, by connecting the respective input positions chronologically, it is possible to recognize letters or lines accurately.

As described above, only one position on the input system is detected at one point in time, and therefore, the input detection is not affected of inputs from another input tool. Thus, even when a plurality of input tools (input styli, for example) are used for continuous input at the same time, inputs of the respective input tools can be accurately detected.

In an embodiment of the input system of the present invention, in addition to the configuration described above, it is preferable that the input device include: a control part that generates a control signal that defines sensing timings for the inputs of the respective input tools, the control part sending the control signal to the respective input tools; and an output part that senses the inputs of the input tools based on the control signal, that the input tool have a receiver that receives the control signal, and provide an input to the input device based on the received control signal, and that the input tools provide an input to the input device based on the control signal at different timings from each other.

With this configuration, the input tool provides an input to the input device based on the control signal, and therefore, when an optical stylus is used as the input tool, for example, it is not necessary to have the optical stylus constantly emit light, and instead, the optical stylus can be configured to emit light only during the sensing operation.

As a result, as compared with the case in which the input tool is constantly in a sensing-ready state, the power consumption relating to the input operation can be reduced.

In an embodiment of the input system of the present invention, in addition to the configuration described above, it is preferable that the input device include: a control part that generates a control signal that defines sensing timings for the inputs of the input tools; a light source that emits infrared light based on the control signal; and an output part that senses the inputs of the input tools based on the control signal, that the input tools each include a photodiode that generates a light-receiving signal after receiving the infrared light, and provide an input to the input device based on the light-receiving signal, and that the input tools provide an input to the input device based on the light-receiving signal at different timings from each other.

With this configuration, the input tool provides an input to the input device only when the infrared light as the control signal is detected by the photodiode of the input tool, and therefore, when an optical stylus is used as the input tool, for example, it is not necessary to have the optical stylus constantly emit light, and instead, the optical stylus can be configured to emit light only when the infrared light is detected by the photodiode of the input tool, in order words, only during the sensing operation.

As a result, as compared with the case in which the input tool is constantly in a sensing-ready state, the power consumption relating to the input operation can be reduced.

In an embodiment of the input system of the present invention, in addition to the configuration described above, it is preferable that the input device include a control part that generates a control signal that defines sensing timings for the inputs of the input tools, and an output that senses the inputs of the input tools based on the control signal, that the respective input tools exchange with each other an input control signal that controls the input tools such that the input tools provide an input at different timings from each other, the input control signal synchronizing with the control signal.

With the configuration described above, the input tools are configured to provide an input to the input device based on the control signal, and therefore, when an optical stylus is used as the input tool, for example, it is not necessary to have the optical stylus constantly emit light, and instead, the optical stylus can be configured to emit light only during the sensing operation.

As a result, as compared with the case in which the input tool is constantly in a sensing-ready state, the power consumption relating to the input operation can be reduced.

When an optical stylus is used as the input tool, for example, it is not necessary to have the optical stylus constantly emit light, and instead, the optical stylus can be configured to emit light only when the infrared light is detected by the photodiode of the input tool, in order words, only during the sensing operation.

As a result, as compared with the case in which the input tool is constantly in a sensing-ready state, the power consumption relating to the input operation can be reduced.

In an embodiment of the input system of the present invention, in addition to the configuration described above, it is preferable that the input tool include a pressure signal generator that generates a pressure signal by detecting a pressure produced when the tip of each of the input tools is pressed against the input device, and that the input tools do not provide an input to the input device unless the pressure signal is generated.

With this configuration, if the pressure signal is generated, that means that the user intends to conduct an input operation, and the input tool can provide an input (based on the control signal) only when the pressure signal is generated. This makes it possible to prevent an input operation from being conducted unintentionally. Specifically, in a case in which an optical stylus is used as the input tool, with this configuration, the input tool does not emit light when the optical stylus is not pressed against the input tool, or in order words, when the user is not trying to conduct an input operation. As a result, it is possible to reduce the power consumption due to unnecessary light emission, and also it is possible to prevent erroneous input.

In one embodiment of the input system of the present invention, specifically, the input tool may have a light-emitting element emitting light as a method to provide an input to the input device, and the input device may receive the light from the light-emitting element, and detect the position where the light was received as the input position.

In another specific example, the input system of the present invention may be configured such that the input tool has a coil that changes a magnetic field as a method to provide an input to the input device, and the input device detects a change in magnetic field caused by the coil, and identifies the position where the change was detected as the input position.

In one embodiment of the input system of the present invention, as yet another specific example, the input system may be configured such that the input tool conducts an input operation by emitting infrared light to the input device, and the input device has a plurality of light-receiving elements for receiving the infrared light emitted by the input tool from different positions, and the input device detects the position where the infrared light was radiated to as the input position based on the results from the plurality of light-receiving elements.

In one embodiment of the input system of the present invention, in addition to the configurations above, it is preferable that the input tools receive the control signal through wireless communication.

With this configuration, it is not necessary to provide wiring lines for the input signal to receive the control signal, which makes it possible to improve the freedom in operating the input tool and user-friendliness of the input tool. In the case of the present invention, in particular, because the plurality of input tools are used, it is effective to allow wireless communication.

In one embodiment of the input system of the present invention, in addition to the configurations above, it is preferable that the input tools transmit and receive the input control signal through wireless communication.

With this configuration, it is not necessary to connect the respective input signals to each other, which makes it possible to improve the freedom in operating the input tool and user-friendliness of the input tools. In the case of the present invention, in particular, because the plurality of input tools are used, it is effective to allow wireless communication.

### INDUSTRIAL APPLICABILITY

The present invention can be applied to an input device of various types of electronic devices as an input device that includes a liquid crystal panel that has both a display function and a touch panel function.

### DESCRIPTION OF REFERENCE CHARACTERS

1a to 1e input system
2 optical stylus, first optical stylus, second optical stylus (input tool)
3, 33 input device
5 control board
6 photosensor touch panel
7 battery
8 display part
10 recognition engine (control part, output part)
20 electromagnetic stylus (input tool)
21 stylus (input tool)
22 coil in electromagnetic stylus
25a, 25b infrared camera (light-receiving element)
30 coil in input device
70 display device
76 group of operation buttons
AMP amplifier circuit
BL backlight
BT, BT-1, BT-2 Bluetooth (registered trademark) communication circuit
C capacitance
CLKi clock signal line
DCS display control circuit
GD gate driver
Gj scan signal line
IC timing
IRG infrared light generator
IRL infrared light
LED light-emitting diode (light-emitting element)
LGC logic part
LOD photosensor output circuit
LSD photosensor driver circuit
MC-1 microcomputer (pressure signal generator)
MC-2 microcomputer
MRY memory
OUT photosensor output line
PD photodiode
PIE pressure element
Pj pixel
RSTi reset signal line
RWSi read-out signal line
SD source driver
SEi photosensor circuit
SL data signal line
SPD photodiode
Sei photosensor circuit
TRA transistor
TRB transistor

1. An input system, comprising: a plurality of input tools; and an input device that can recognize input positions by sensing inputs of the input tools,
wherein input timings of the respective input tools are configured to differ from each other, and the input device senses the inputs in accordance with the input timings of the respective input tools, and
wherein the input device connects input positions chronologically to detect continuous inputs for each of the input tools.

2. The input system according to claim 1, wherein the input device includes: a control part that generates a control signal that defines sensing timings for the inputs of the respective input tools, the control part sending the control signal to the respective input tools; and a detection part that senses the inputs of the input tools based on the control signal,
wherein the input tools each have a receiver that receives the control signal, and provide an input to the input device based on the received control signal, and
wherein the input tools each provide an input to the input device based on the control signal at different timings from each other.

3. The input system according to claim 1, wherein the input device includes: a control part that generates a control signal that defines sensing timings for the inputs of the respective input tools; a light source that emits infrared light based on the control signal; and a detection part that senses the inputs of the input tools based on the control signal,
wherein the input tools each include a photodiode that generates a light-receiving signal after receiving the infrared light, the input tools each providing an input to the input device based on the light-receiving signal, and
wherein the input tools each provide an input to the input device based on the light-receiving signal at different timings from each other.

4. The input system according to claim 1, wherein the input device includes: a control part that generates a control signal that defines sensing timings for the inputs of the respective input tools; and a detection part that senses the inputs of the input tools based on the control signal, and
wherein the respective input tools exchange with each other an input control signal that controls the input tools such that the input tools provide an input at different timings from each other, the input control signal synchronizing with the control signal.

5. The input system according to claim 1, wherein the input tools each include a pressure signal generator that generates a pressure signal by detecting a pressure produced when a tip of each of the input tools is pressed against the input device, and
wherein the input tools do not provide an input to the input device unless the pressure signal is generated.

6. The input system according to claim 1, wherein the input tools each have a light-emitting element emitting light as a method to provide an input to the input device, and
wherein the input device receives the light from the light-emitting element, and detects a position where the light was received as the input position.

7. The input system according to claim 1, wherein the input tools each have a coil that changes a magnetic field as a method to provide an input to the input device, and
wherein the input device detects a change in magnetic field caused by the coil, and detects a position where the change occurred as the input position.

8. The input system according to claim 1, wherein the input tools provide an input by emitting infrared light to the input device, and
wherein the input device has a plurality of light-receiving elements at different positions for receiving the infrared light emitted by the input tool, and the input device detects the position where the infrared light was radiated to as the input position, based on results provided by the plurality of light-receiving elements.

9. The input system according to claim 2, wherein the input tools receive the control signal through wireless communication.

10. The input system according to claim 4, wherein the input tools receive the input control signal through wireless communication.
